(19) United States
(12) Patent Application Publication
(10) Pub. No.: US 2008/0296411 A1
(43) Pub. Date: Dec. 4, 2008

(54) Fuel Injection Valve for an Internal Combustion Engine

(76) Inventors: Rudolf Heinz, Renningen (DE); Patrick Mattes, Stuttgart (DE); Wolfgang Stoecklein, Stuttgart (DE); Holger Rapp, Ditzingen (DE); Marcus Schilling, Weingarten (DE); Violaine Chassagnoux, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/793,052

(22) PCT Filed: Nov. 15, 2005
(86) PCT No.: PCT/EP05/55989

§ 371 Date: Feb. 13, 2008

(30) Foreign Application Priority Data
Dec. 16, 2004 (DE) 102004060552.1

(51) Int. Cl. F02M 61/00

(52) U.S. Cl. 239/533.2; 123/445

(57) ABSTRACT

A fuel injection valve with a valve member axially displaceable in a bore of a valve body comprises a valve stem, the combustion chamber end, with which it interacts with a valve face of the valve body, at least one injection opening downstream of the valve face and opening into the combustion chamber to be supplied with fuel, a guide section of the valve body guiding the valve member and being disposed axially between an annular gap connected to the high-pressure fuel line and an annular space leading to the valve face, a first throttle connection permanently interlinking the annular gap and the annular space, and a second throttle connection interlinking the annular gap and the annular space as of a defined opening stroke of the valve member and having a smaller throttle resistance than the first throttle connection. The guide section is configured by a guide sleeve that is fastened at the combustion chamber end of the valve body in the bore so as to be stationary.

### PRIOR ART

The invention is based on a fuel injection valve as generically defined by the preamble to claim 1.

One such fuel injection valve has become known for instance from U.S. Pat. No. 4,987,887.

For reducing emissions, especially in view of the EURO-V standard, it is known to shape the injection course of fuel injection valves as a function of the nozzle needle stroke with a view to optimal combustion. To that end, a reference throttling of the fuel upon injection is performed, for which purpose in particular two throttle connections of different throttle resistance that are disposed parallel can be used. The first throttle connection permanently connects an annular gap with an annular chamber that discharges at the valve seat face, while the second throttle connection is activated beyond a predetermined opening stroke.

### ADVANTAGES OF THE INVENTION

The fuel injection valve of the invention for internal combustion engines having the definitive characteristic of the body of claim 1 has the advantage over the prior art that the reference throttling can be done in an especially simple way by embodying the guide portion as a guide sleeve. By means of the guide sleeve, as long as the stroke of the valve member has not yet exceeded the predetermined opening stroke, the second throttle connection is closed entirely, or almost entirely. As a result, the pressure at the valve seat face is lowered compared to the rail pressure prevailing upstream of the first throttle connection, and the hydraulically effective surface area of the face where the rail pressure acts on the valve member for embodying a hydraulic opening force is reduced. This brings about a reduction in the opening speed of the valve member below the predetermined opening stroke. If the predetermined opening stroke is exceeded, then the second throttle connection is activated, and the rail pressure now prevails as far as the valve seat face. The hydraulically effective surface area and the pressure at the injection openings now develop as in known common rail nozzles. In addition, conventional guidance of the valve member can optionally be dispensed with.

The first throttle connection with the greater throttle resistance can be formed by an annular gap between the guide sleeve and the valve member, by a ground and polished surface of the valve member, or by a throttle bore in the guide sleeve or in the valve member. The second throttle connection may be produced by means of a further ground and polished surface of the valve member or a throttle bore in the valve member or in the guide sleeve. By means of a spring between the guide sleeve and the valve member, secure contact of the guide sleeve with the valve body can be attained.

Further advantages of the invention will become apparent from the description and the drawings. The aforementioned characteristics and those listed hereinafter can also be employed each on their own or a plurality may be used in arbitrary combinations. The embodiments shown and described are not to be understood as a conclusive list; on the contrary, they are in the nature of examples for the sake of describing the invention.

### DRAWINGS

Exemplary embodiments of the fuel injection valve of the invention are shown in the drawings, which are not to scale, and are described in further detail in the ensuing description.

FIG. 1 shows a schematic illustration of a first embodiment of the fuel injection valve of the invention, with a guide sleeve as its guide portion;

FIG. 2 shows a detail of the combustion chamber end of the fuel injection valve of FIG. 1, with two ground and polished surfaces of a valve member serving as throttle connections;

FIG. 3 shows a detail of the combustion chamber end of a second embodiment of the fuel injection valve of the invention, with a throttle bore in the valve member as a second throttle connection;

FIG. 4 shows a detail of the combustion chamber end of a third embodiment of the fuel injection valve of the invention, with a throttle bore in the valve member as a first throttle connection;

FIG. 5 shows a detail of the combustion chamber end of a fourth embodiment of the fuel injection valve of the invention, with a throttle bore in the guide sleeve;

FIG. 6 shows a detail of the combustion chamber end of a fifth embodiment of the fuel injection valve of the invention, with two throttle bores in the guide sleeve; and

FIG. 7, in a first portion (a), shows the throttle resistance and in a second portion (b) shows the injection quantity of the fuel injection valve of the invention as a function of the opening stroke.

### DESCRIPTION OF THE EXEMPLARY EMBODIMENTS

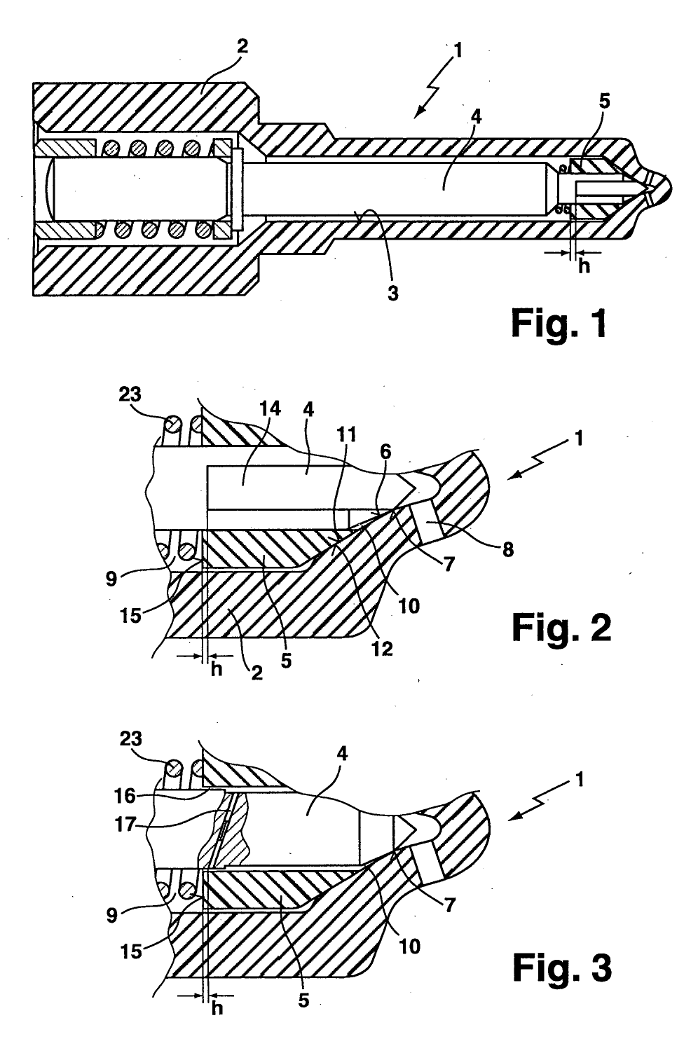

FIG. 1 shows a fuel injection valve 1 for internal combustion engines, which is designed as a nozzle module, of the kind used in CR injectors, among others, with a piezoelectric actuator. The fuel injection valve 1 has a valve body 2, in which a bore 3 is provided. A valve member 4 is mounted axially displaceably in the bore 3 and is guided in the interior of the bore 3 by means of a guide sleeve 5 acting as a guide portion.

FIG. 2 shows the combustion chamber end of the fuel injection valve 1 in detail. The valve member 4, on its combustion chamber end, has a valve sealing face 6, with which, in the closed state of the fuel injection valve 1, it rests on a valve seat face 7 of the valve body 2 in order to prevent a flow of fuel to injection openings 8 provided downstream of the valve seat face 7. The injection openings 8 open into the combustion chamber of the engine to be supplied. The guide sleeve 5 is provided axially between an annular gap 9, connected to a high-pressure fuel line, not shown in the drawing, and an annular chamber 10 that discharges at the valve seat face 7. The guide sleeve 5, in the direction of the combustion chamber end of the valve body 2, has a conical face portion 11, which is press-fitted into a conically tapering face portion 12 of the valve body 2. For the fixation of the guide sleeve 5, a spring 23 is provided, which presses in the axial direction against a radially extending control edge 15 of the guide sleeve 5 and fixes the control sleeve 5 immovably.

The outer wall of the valve member 4 is hydraulically tightly flush with the inner wall of the guide sleeve 5. A first, long ground and polished surface of the valve member 4, not shown in the drawing and acting as a throttle connection, connects the annular gap 9 permanently with the annular chamber 10. A second, shorter ground and polished surface 14, which serves as a second throttle connection, connects the annular gap 9 and the annular chamber 10 beyond a predetermined opening stroke h of the valve member 4, which in the present case amounts to approximately 0.1 mm. Once the opening stroke h is reached, the valve member 4 is tightened to such an extent that the second ground and polished surface 14 protrudes with one end past the control edge 15 of the guide sleeve 5 into the annular gap 9 and makes the delivery of fuel into the injection openings 8 possible with a reduced throttle resistance.

Identical reference numerals as in FIGS. 1 and 2 will be employed hereinafter for characteristics having the same function and the same or a similar structure.

FIG. 3 shows a detail of a second embodiment of the fuel injection valve 1, in which an annular gap 16, which as a first throttle connection connects the annular gap 9 permanently to the annular chamber 10, is embodied between the valve member 4 and the guide sleeve 5. The annular chamber 10 discharges at the valve seat face 7 and is formed between the valve member 4 and the guide sleeve 5 by means of a reduction in the diameter of the valve member 4. A throttle bore 17 is drilled into the valve member 4 and connects the axial portion of the valve member 4, having the larger diameter, where the annular gap 16 is formed, to the portion of the valve member having the smaller diameter, where the annular chamber 10 is formed. The throttle bore 17, from the opening stroke h onward, connects the annular gap 9 to the annular chamber 10, so that the delivery of fuel into the injection openings 8 with a reduced throttle resistance is made possible.

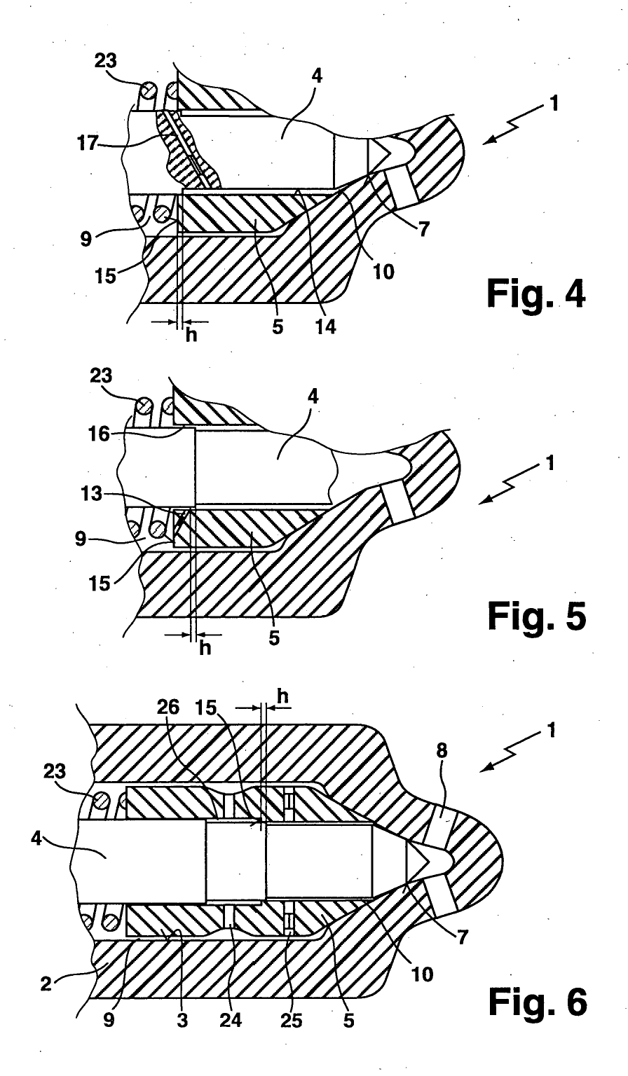

FIG. 4 shows a detail of a third embodiment of the fuel injection valve 1, in which unlike FIG. 3, the portion of the valve member 4 with the larger diameter is hydraulically tightly flush with the guide sleeve 5. As the first throttle connection, the throttle bore 17 of the valve member 4 connects the annular gap 9 to the ground and polished surface 14, which is formed on the valve member 4 and is embodied as shown in FIG. 1 and is in communication with the annular chamber 10. Once the opening stroke h is reached, the control edge 15 uncovers the ground and polished surface 14, so that the latter communicates directly with the annular gap 9.

FIG. 5 shows a detail of a fourth embodiment of the fuel injection valve 1, in which a throttle bore 13 is drilled as a second throttle connection into the guide sleeve 5. The throttle bore 13 connects the inside face of the guide sleeve 5 permanently to the control edge 15 of the guide sleeve 5. The valve member 4 of the fuel injection valve 1 of FIG. 5 is constructed analogously to the valve member 4 of FIG. 3, but it has no throttle bore. As in FIG. 3, an annular gap 16 is formed between the guide sleeve 5 and a portion of the valve member 4 having the larger diameter, into which the throttle bore 13 discharges when the fuel injection valve 1 is closed. From the opening stroke h on, the throttle bore 13 no longer discharges into the annular gap 16 but rather into the annular gap 10, which is formed between the portion of the valve member 4 having the lesser diameter and the guide sleeve 5.

FIG. 6 shows a further embodiment of the fuel injection valve 1, with a guide sleeve 5 which in comparison to the guide sleeves shown in FIGS. 1 through 5 is lengthened in the axial direction, in order to facilitate the closure of the fuel injection valve 1. The guide sleeve 5 has two cylindrical portions of different inside diameters, of which the larger is formed on the end of the guide sleeve 5 facing away from the combustion chamber, while the smaller is formed on the end of the guide sleeve toward the combustion chamber. The two portions of the guide sleeve 5 are adjacent to one another at a control edge 15 which is formed in the radial direction between the cylindrical portions.

The valve member 4 has three portions of different diameters, which decrease from the end of the valve member 4 remote from the combustion chamber to the end toward the combustion chamber. The portions with the greatest and the medium diameter of the valve member 4 are embodied in such a way that when the fuel injection valve 1 is closed, they are each hydraulically tightly flush with the inside diameters of the guide sleeve 5. The portion of the valve member 5 have the smallest diameter, together with the portion toward the combustion chamber of the guide sleeve, forms the annular chamber 10. Between the portion having the medium diameter of the valve member 4 and the portion of the guide sleeve 5 that is remote from the combustion chamber, an annular chamber 26 is formed.

The guide sleeve 5, on a combustion chamber end, has two radially extending first throttle bores 25, which act as first throttle connections. The first throttle bores 25 extend between the outer wall and the inner wall of the guide sleeve 5. Between the outer wall of the guide sleeve 5 and the inner wall of the bore 3, the annular gap 9 is formed. The annular gap 9 communicates with the annular chamber 10 via the first throttle bores 25. Four second throttle bores 24, extending in the radial direction, in the guide sleeve 5 are made farther away from the combustion chamber in the axial direction than the first throttle bores 25 and serve as second throttle connections. The second throttle bores 24 connect the annular gap 9 to the annular chamber 26. The annular chamber 26 is hydraulically sealed off from the annular chamber 10 until the nozzle stroke h is reached, because the portion of the valve member 4 having the medium diameter is hydraulically tightly flush with the combustion chamber portion of the guide sleeve 5. When the nozzle stroke h is reached, the control edge 15 uncovers the portion of the valve member 4 having the larger diameter, so that the annular chamber 26 is in communication with the annular chamber 10. Via the second throttle bores 24, which have only a slight (virtually zero) throttling action, fuel is delivered to the injection openings 8.

In the fuel injection valves 1 shown in FIGS. 1 through 5, the first throttle connection, instead of being embodied by the first ground and polished surface, the annular gap 16, or the throttle bore 17 in the valve member 4, may alternatively be embodied by a radial throttle bore in the guide sleeve 5, as shown in FIG. 6.

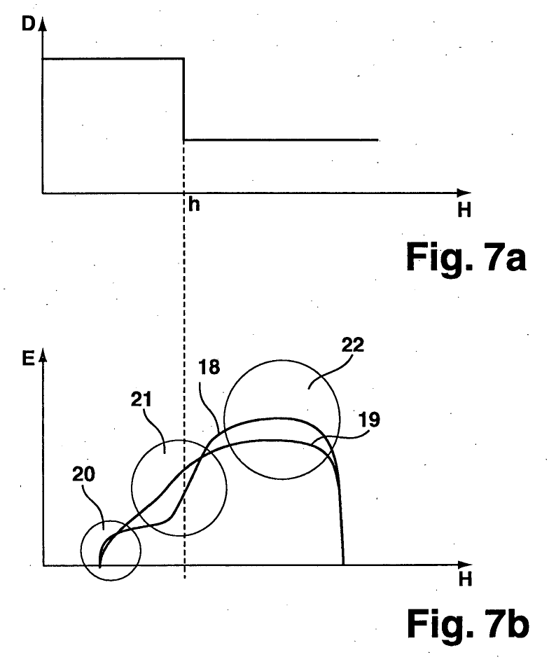

FIG. 7a shows a throttle resistance D of the fuel injection valve 1 as a function of the opening stroke H. Up to the opening stroke h, the first throttle connection, which has a constant, major throttling action, is the only one in action. Beyond the opening stroke h, the second throttle connection is in action as well and reduces the throttle resistance D to the lesser, also constant value. The lesser value can be very slight; it is even possible to reduce it to zero.

The injection quantity E into the combustion chamber, when two throttle connections of different throttle resistance are employed, is shown in FIG. 7b in terms of a first injection curve 18. For comparison, a second injection curve 19 shows the injection quantity when only a single throttle connection is employed, whose throttle resistance is between the two throttle resistances shown in FIG. 7a. In a first injection region 20 with a slight opening stroke, the first throttle connection with the greater throttle resistance acts as the sole throttle connection. Because of the reduced pressure in the annular chamber 10, the hydraulic opening force on the valve member and thus also the opening speed of the valve member is reduced in this lower stroke range.

In a second injection region 21 with a medium opening stroke (during the ignition delay), less fuel is injected in the first injection curve 18 than in the second injection curve 19. As the valve member opens to a greater extent, in a third injection region 22 the second throttle connection with the lesser throttle resistance determines the injection behavior and leads to a greater injection quantity in the actual combustion than when only one throttle connection is employed. The injection course, by the use of two throttle connections of different throttle resistance, can therefore be set far more precisely with a view to optimal combustion than if only a single throttle connection is used. The guide sleeve is especially well suited to the provision of throttle connections and furthermore leads to a reduction in the hydraulic surface area.

1-11. (canceled)

12. In a fuel injection valve for internal combustion engines, the injection valve having a valve member, which is axially displaceable in a bore of a valve body and which on its combustion chamber end has a valve sealing face with which it cooperates with a valve seat face of the valve body, having at least one injection opening downstream of the valve seat face and opening into the combustion chamber of the engine to be supplied, having a guide portion which guides the valve member and is disposed axially between an annular gap connected to a high-pressure fuel line and an annular chamber opening out to the valve seat face having a first throttle connection permanently connecting the annular gap and the annular chamber with one another, and having a second throttle connection connecting the annular gap and annular chamber together beyond a predetermined opening stroke of the valve member, the second throttle connection having a lesser throttle resistance than the first throttle connection, the improvement wherein
the guide portion is formed by a guide sleeve disposed on the combustion chamber end of the valve body in the bore.

13. The fuel injection valve as defined by claim 12, wherein the first throttle connection is formed by an annular gap between the guide sleeve and the valve member.

14. The fuel injection valve as defined by claim 12, wherein the first throttle connection is formed by at least one first ground and polished surface of the valve member.

15. The fuel injection valve as defined by claim 12, wherein the first throttle connection is formed by a throttle bore in the guide sleeve.

16. The fuel injection valve as defined by claim 12, wherein the second throttle connection is formed by at least one second ground and polished surface of the valve member.

17. The fuel injection valve as defined by claim 13, wherein the second throttle connection is formed by at least one second ground and polished surface of the valve member.

18. The fuel injection valve as defined by claim 14, wherein the second throttle connection is formed by at least one second ground and polished surface of the valve member.

19. The fuel injection valve as defined by claim 15, wherein the second throttle connection is formed by at least one second ground and polished surface of the valve member.

20. The fuel injection valve as defined by claim 12, wherein the second throttle connection is formed by a throttle bore extend in the valve member.

21. The fuel injection valve as defined by claim 13, wherein the second throttle connection is formed by a throttle bore extend in the valve member.

22. The fuel injection valve as defined by claim 14, wherein the second throttle connection is formed by a throttle bore extend in the valve member.

23. The fuel injection valve as defined by claim 15, wherein the second throttle connection is formed by a throttle bore extend in the valve member.

24. The fuel injection valve as defined by claim 12, wherein the second throttle connection is formed by a throttle bore extend in the guide sleeve.

25. The fuel injection valve as defined by claim 13, wherein the second throttle connection is formed by a throttle bore extend in the guide sleeve.

26. The fuel injection valve as defined by claim 14, wherein the second throttle connection is formed by a throttle bore extend in the guide sleeve.

27. The fuel injection valve as defined by claim 15, wherein the second throttle connection is formed by a throttle bore extend in the guide sleeve.

28. The fuel injection valve as defined by claim 12, wherein the guide sleeve is immovably fixed in the bore of the valve body.

29. The fuel injection valve as defined by claim 12, wherein the valve member at least in the portion of the guide sleeve that discharges at the valve seat face, has a smaller diameter than in the portion that discharges at the annular gap.

30. The fuel injection valve as defined by claim 12, wherein the guide sleeve has a conical face portion which is immovably fixed in a conically tapering face portion of the valve body.

31. The fuel injection valve as defined by claim 12, further comprising a spring disposed in the axial direction between the valve member and the guide sleeve and pressing the guide sleeve against the valve body.
